(19) United States
(12) Patent Application Publication
(10) Pub. No.: US 2004/0167231 A1
(43) Pub. Date: Aug. 26, 2004

(54) Method for producing W/O-type suspension

(76) Inventor: Tetsuo Kawagoe, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/368,563

(22) Filed: Feb. 20, 2003

(51) Int. Cl. B01F 3/08

(52) U.S. Cl. 516/21

(57) ABSTRACT

A method for producing W/O-type suspension may comprise: mixing water and oil to form water-oil mixture; and driving the water-oil mixture in a flow path so as to make the water-oil mixture into W/O-type emulsion in a static electrification condition. The flow path may include a metal heat exchanger. The method may further comprise: adding activity compound of hydrophobic nature into the water-oil mixture, the activity compound having atoms with an electronegativity higher than electronegativity of hydrogen; slowing down the driving of the water-oil mixture in the flow path so as to adsorb the activity compound on the surface of the heat exchanger; and cooling the heat exchanger on the opposite side of the emulsion while circulating the emulsion through the flow path so as to produce W/O-type suspension. The oil and the activity compound are preferably non-cognate.

### BACKGROUND OF THE INVENTION

This invention is related generally to a method for producing W/O-type (water/oil-type) suspension, and more particularly to a method for producing W/O-type suspension which may be used in dynamic ice thermal storage system with an enhanced ice packing factor (IPF). W/O-type suspension has a continuous medium of oil and separate particles of ice (water) floating in the oil, and a W/O-type suspension includes O/W/O-type suspension which has oil droplets within the ice particles or water drops in oil continuum.

Dynamic ice thermal storage system is known in the art for compensating daily fluctuation in electric power demand. The ice is formed and stored using electric power during late night hours when general electric power demand is small, and the stored ice may be used as a cold heat source for air conditioning and cooling of perishable foods or flowers during day hours when general electric power demand is large.

In a conventional dynamic ice thermal storage system, W/O-type suspension is used for continuously producing ice which can flow in a pipe line as sherbet ice.

Japanese Patent Publication No. 09-248444, the entire content of which is incorporated herein by reference, discloses a method for producing sherbet ice or W/O-type suspension by adding activity compound in a mixed solution of water and oil. The added activity compound has atoms with an electronegativity higher than 2.1 of hydrogen.

The mixture of water and oil with the additional activity compound is forced to circulate in a circulation loop including a pipe line and a heat exchanger, and then, a W/O-type emulsion is formed. Consequently, the inner surface of the heat exchanger incorporated in the circulation loop is adsorbed by hydrogen bond in an oil film.

Then, the heat exchanger is cooled by a medium outside of the emulsion while the emulsion is circulated. Consequently, the water in the emulsion freezes into ice, and the W/O-type emulsion turns into a W/O-type suspension in the heat exchanger. An oil film suppresses the ice adhesion which might otherwise grow by hydrogen bonds to block the flow passages for the suspension in the heat exchanger. Thus, suspension can be continuously produced.

However, the method disclosed in the Japanese Patent Publication cited above has been found to have problems as follows:

(1) When the mixture of water and oil with the additive activity compound is circulated to form an oil film over the heat exchanger solid surface, part of the additive activity compound solves into the oil, and the effect of the additive activity compound is degraded. If the amount of the additive compound is increased over about 3 volume-percent in order to enhance the effect of the compound, the suspension is apt to become mousse-like state, which would hinder smooth flow of the suspension. In addition, excessive addition of the activity compound would result in lowering freezing temperature, and then, efficiency of the suspension producing facility would be deteriorated. Thus, the operation cost of this facility would be enhanced.

(2) In order to suppress heat resistance in the adsorption oil film, the oil film should be thin, preferably less than 0.1 micrometer in thickness. However, such a thin, stable oil film could not be formed on the inner surface of the heat exchanger which has a complex shape.

### BRIEF SUMMARY OF THE INVENTION

Accordingly, it is an object of the present invention to provide a method for producing W/O-type suspension with relatively small amount of additive compound, the method including forming a stable, thin oil film on the wall surface of the heat exchanger.

There has been provided, in accordance with an aspect of the present invention, a method for producing W/O-type suspension may comprise: mixing water and oil to form water-oil mixture; and driving the water-oil mixture in a flow path so as to make the water-oil mixture into W/O-type emulsion in a static electrification condition. The flow path may include a metal heat exchanger. The method may further comprise: subsequently, adding activity compound of hydrophobic nature into the water-oil mixture, the activity compound having atoms with an electronegativity higher than electronegativity of hydrogen; subsequently, slowing down the driving of the water-oil mixture in the flow path so as to adsorb the activity compound on the surface of the heat exchanger; and subsequently, cooling the heat exchanger on the opposite side of the emulsion while circulating the emulsion through the flow path so as to produce W/O-type suspension. The oil and the activity compound are preferably non-cognate.

There has also been provided, in accordance with another aspect of the present invention, a method for producing W/O-type suspension may comprise adding activity compound of hydrophobic nature into water. The activity compound may have atoms with an electronegativity higher than electronegativity of hydrogen. The method may further comprise driving the water with the activity compound in a circulation flow path including a metal heat exchanger so as to adsorb the activity compound on the surface of the heat exchanger. The method may further comprise: subsequently, mixing oil and the water with the activity compound to form a mixture; and subsequently, driving the mixture in the flow path so as to make the mixture into W/O-type emulsion in a static electrification condition. The method may further comprise subsequently, cooling the heat exchanger on the opposite side of the emulsion while circulating the emulsion through the flow path so as to produce W/O-type suspension.

The oil and the activity compound are preferably non-cognate.

### BRIEF DESCRIPTION OF THE DRAWINGS

The above and other features and advantages of the present invention will become apparent from the discussion hereinbelow of specific, illustrative embodiments thereof presented in conjunction with the accompanying drawings, in which:

FIG. 1 is a schematic diagram of a typical dynamic ice thermal storage system, which may suit for a method for producing W/O-type suspension according to the present invention;

FIG. 2 is a flow chart of a first embodiment of the method for producing W/O-type suspension according to the present invention; and

FIG. 3 is a flow chart of a second embodiment of the method for producing W/O-type suspension according to the present invention.

### DETAILED DESCRIPTION OF THE INVENTION

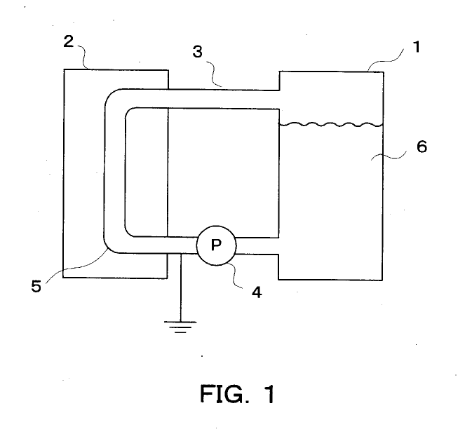

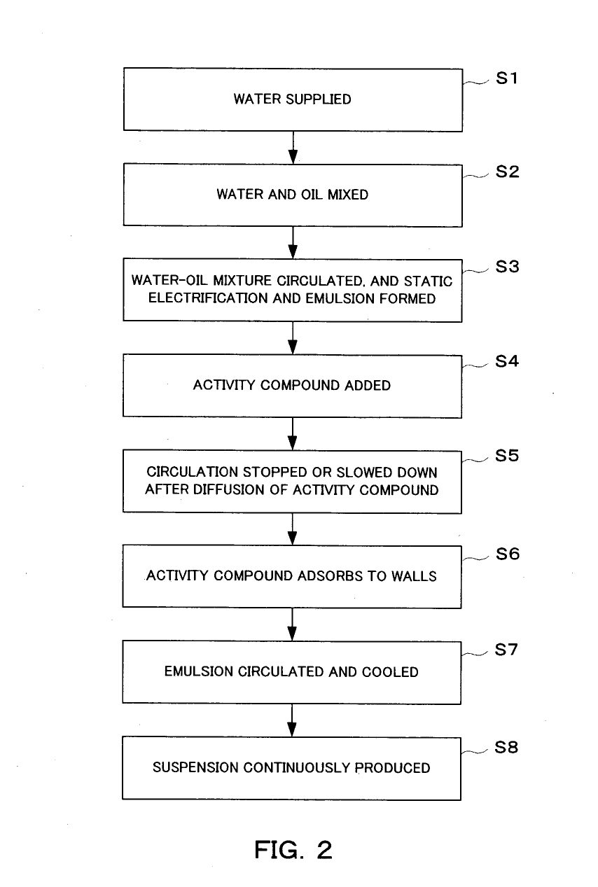

Now a first embodiment of a method for producing W/O-type suspension according to the present invention is described with reference to FIGS. 1 and 2.

FIG. 1 is a schematic diagram of a typical dynamic ice thermal storage system, which may suit for a method for producing W/O-type suspension according to the present invention. Referring to FIG. 1, a circulation pipe 3 is connected to a thermal storage tank 1, so as to form a closed loop. The thermal storage tank 1 is used for storing the mixed solution of water and oil 6 as discussed in detail below. A circulation pump 4 is installed in the circulation pipe 3. Part of the circulation pipe 3 forms a heat exchanger 5 which is disposed in a cooling device 2. Coolant such as gas or brine is provided outside of the heat exchange 5 in the cooling device 2. The circulation pipe 3 is electrically ground.

Now, the first embodiment of the method for producing W/O-type suspension using the dynamic ice thermal storage system shown in FIG. 1 is discussed referring to FIG. 2. At the first step (Si), water such as tap water is supplied to the thermal storage tank 1. Then, oil with low viscosity such as kerosene is supplied to the thermal storage tank 1, and the water and the oil are mixed together in the thermal storage tank 1 (S2). The volume percentage of the oil may be about 15%, for example.

And then, the circulation pump is activated, and the mixture of the water and oil is circulated in the thermal storage tank 1 and the circulation pipe 3 including the heat exchanger 5 (S3). By circulation or stirring of the water-oil mixture, a static electrification emerges and W/O-type emulsion is formed. The water is charged in plus while the oil is charged in minus, due to the difference in dielectric constants. Since the metal heat exchanger 5 and the circulation pipe 3 are charged in plus likewise, the circulation pipe 3 is grounded to lower the voltage level.

Then, activity compound of hydrophobic nature is added into the water-oil mixture (S4). The activity compound should have atoms with an electronegativity higher than the electronegativity of hydrogen that is 2.1. Such atoms may be selected from nitrogen, fluoride, chlorine and oxygen, the electronegativities of which are 3.0, 4.0, 3.0 and 3.5, respectively. The activity compound may be amino group modified oil such as amino group modified silicone oil, for example. The resulting volume percent composition may be, for example, 85% of tap water, 14% of kerosene and 1% of amino group modified silicone oil.

Although the above-mentioned activity compound is hydrophobic in normal state, it acts hydrophilic and makes W/O-type emulsion when the water is in a static electrification condition. At the same time, the activity compound becomes to be less soluble into the oil when the oil is in a static electrification condition.

The oil and the activity compound are preferably non-cognate. If the oil and the activity compound are cognate, the resultant suspension is apt to become mousse-like state, which would hinder smooth flow of the suspension.

When the activity compound has diffused throughout the circulation loop, the circulation pump 4 is stopped or is slowed down (S5). This state is maintained for several hours, during which the added activity compound may adsorb to the inner walls of the circulation loop including the heat exchanger 5, the circulation pipe 3 and the thermal storage tank 1 (S6).

Then, the circulation pump 4 is activated in a normal speed, and the cooling device 2 is activated (S7). Thus, the suspension is continuously produced in the cooling device 2, and is carried to the thermal storage tank 1 to be stored there (S8).

According to the first embodiment described above, the hydrogen bonding of the added activity compound is utilized, and the oil film on the heat exchanger wall surface, which may be complicated in shape, can be maintained for a long time. In addition, according to this embodiment, the IPF can be enhanced to about 80% compared to 30% of the conventional method. Furthermore, this method of producing W/O-type suspension may be simple and economical.

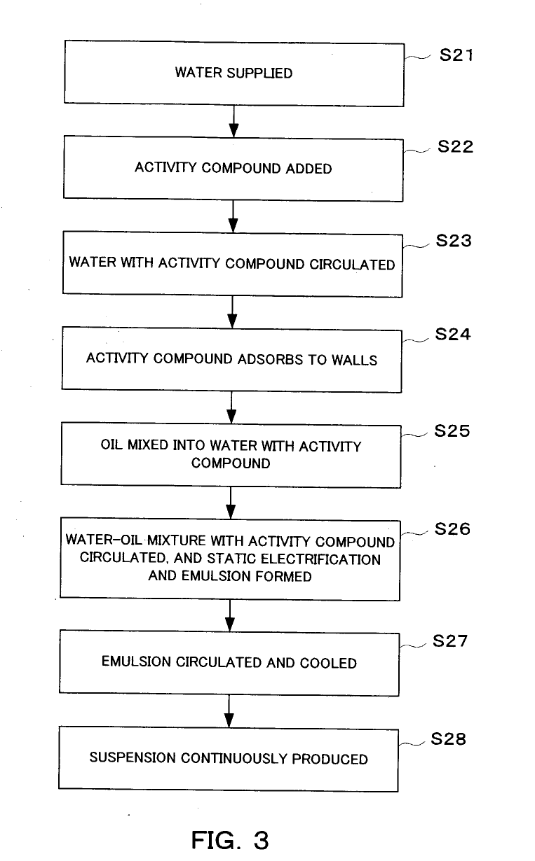

Now, a second embodiment of the method for producing W/O-type suspension is discussed referring to FIG. 3. The dynamic ice thermal storage system shown in FIG. 1, as well as the water, the oil and the activity compound of the same types may be used as in the first embodiment.

At the first step (S21), the water is supplied to the thermal storage tank 1. Then, the activity compound is added into the water (S22).

And then, the circulation pump is activated, and the water with the activity compound is circulated in the thermal storage tank 1 and the circulation pipe 3 including the heat exchanger 5 (S23). Thus, the activity compound may diffuse throughout the circulation loop.

When the activity compound has diffused throughout the circulation loop, the circulation pump 4 is stopped or is slowed down. This state is maintained for several hours, during which the added activity compound may adsorb to the inner walls forming the circulation loop including the heat exchanger 5, the circulation pipe 3 and the thermal storage tank 1 (S24).

And then, the oil is mixed into the water with the activity compound (S25). Then, the circulation pump is activated, and the mixture of the water and oil with the activity compound is circulated in the thermal storage tank 1 and the circulation pipe 3 including the heat exchanger 5 (S26). By circulation or stirring the water-oil mixture, a static electrification emerges and W/O-type emulsion is formed.

Then, the circulation pump 4 is activated in a normal speed, and the cooling device 2 is activated (S27). Thus, the suspension is continuously produced in the cooling device 2, and is carried to the thermal storage tank 1 to be stored there (S28).

According to the second embodiment described above, similar effect may be obtained as the first embodiment.

Numerous modifications and variations of the present invention are possible in light of the above teachings. It is, therefore, to be understood that, within the scope of the appended claims, the present invention can be practiced in a manner other than as specifically described herein.

What is claimed is:

1. A method for producing W/O-type suspension, the method comprising:
mixing water and oil to form water-oil mixture;
driving the water-oil mixture in a flow path so as to make the water-oil mixture into W/O-type emulsion in a static electrification condition, the flow path including a metal heat exchanger;
subsequently, adding activity compound of hydrophobic nature into the water-oil mixture, the activity compound having atoms with an electronegativity higher than electronegativity of hydrogen;
subsequently, slowing down the driving of the water-oil mixture in the flow path so as to adsorb the activity compound on the surface of the heat exchanger; and
subsequently, cooling the heat exchanger on the opposite side of the emulsion while circulating the emulsion through the flow path so as to produce W/O-type suspension.

2. The method according to claim 1, wherein the oil and the activity compound are not cognate.

3. A method for producing W/O-type suspension, the method comprising:
adding activity compound of hydrophobic nature into water, the activity compound having atoms with an electronegativity higher than electronegativity of hydrogen;
driving the water with the activity compound in a circulation flow path including a metal heat exchanger so as to adsorb the activity compound on the surface of the heat exchanger;
subsequently, mixing oil and the water with the activity compound to form a mixture;
subsequently, driving the mixture in the flow path so as to make the mixture into W/O-type emulsion in a static electrification condition; and
subsequently, cooling the heat exchanger on the opposite side of the emulsion while circulating the emulsion through the flow path so as to produce W/O-type suspension.

4. The method according to claim 3, wherein the oil and the activity compound are not cognate.
